(19) United States
(12) Patent Application Publication
(10) Pub. No.: US 2024/0393767 A1
(43) Pub. Date: Nov. 28, 2024

(54) COMPUTER VISION-BASED PROCESS CONTROL AND MEASUREMENTS VALIDATION

(71) Applicant: SAUDI ARABIAN OIL COMPANY, Dhahran (SA)

(72) Inventors: Hassan Mohammadali Al Matouq, Al Qatif (SA); Rida Majed Bin Hashim, Safwa (SA); Saeed Mohammed Alamoudi, Jeddah (SA); Ali Homoud Alshehri, Dhahran (SA)

(73) Assignee: SAUDI ARABIAN OIL COMPANY, Dhahran (SA)

(21) Appl. No.: 18/324,494

(22) Filed: May 26, 2023

(51) Int. Cl. G05B 19/4155

(52) U.S. Cl. CPC G05B 19/4155; G05B 2219/41108

(57) ABSTRACT

A method for process control with process measurements validation capability involves obtaining a first actual sensor reading of a process variable from a field sensor to be monitored, and obtaining a first virtual sensor reading of the process variable from a virtual sensor. The virtual sensor is camera-based. The method further involves calculating a first deviation between the first actual sensor reading and the first virtual sensor reading, making a first determination that the first deviation exceeds a prespecified threshold, based on the first determination, making a second determination that the first actual sensor reading does not correspond to first related sensors readings, and based on the second determination, making the first virtual sensor reading a first trusted sensor reading for controlling an aspect of a process associated with the process variable.

### BACKGROUND

Processes, e.g., chemical processes may require parameters to remain within a certain range. For example, in a petrochemical plant such as a refinery or Gas Oil Separation Plant (GOSP), temperatures, pressures, flows, and other parameters may require monitoring and control. Physical transmitters may be used to obtain measurements of these parameters. However, physical transmitters are subject to failures and inaccuracy, which may result in the use of incorrect figures in process control. This, in turn, may lead to faults or even unwanted system shut down. Accordingly, it may be desirable to obtain alternative or additional measurements that may be used to validate the measurement of a transmitter.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for process control with process measurements validation capability, the method comprising: obtaining a first actual sensor reading of a process variable from a field sensor to be monitored; obtaining a first virtual sensor reading of the process variable from a virtual sensor, wherein the virtual sensor is camera-based; calculating a first deviation between the first actual sensor reading and the first virtual sensor reading; making a first determination that the first deviation exceeds a prespecified threshold; based on the first determination, making a second determination that the first actual sensor reading does not correspond to first related sensors readings; and based on the second determination, making the first virtual sensor reading a first trusted sensor reading for controlling an aspect of a process associated with the process variable.

In general, in one aspect, embodiments relate to a system for process control with process measurements validation capability, the system comprising: a field sensor to be monitored, configured to obtain a first actual sensor reading of a process variable; a virtual sensor comprising a camera, the virtual sensor configured to obtain a first virtual sensor reading of the variable; related field sensors, configured to obtain first related sensors readings; and a measurement and validation engine configured to: calculate a first deviation between the first actual sensor reading and the first virtual sensor reading, make a first determination that the first deviation exceeds a prespecified threshold, based on the first determination, make a second determination that the first actual sensor reading does not correspond to the first related sensors readings, and based on the second determination, making the first virtual sensor reading a first trusted sensor reading for controlling an aspect of a process associated with the process variable.

In general, in one aspect, embodiments relate to a non-transitory machine-readable medium comprising a plurality of machine-readable instructions executed by one or more processors of a measurement and validation engine, the plurality of machine-readable instructions causing the one or more processors to obtain a first actual sensor reading of a process variable from a field sensor to be monitored; obtain a first virtual sensor reading of the process variable from a virtual sensor, wherein the virtual sensor is camera-based; calculate a first deviation between the first actual sensor reading and the first virtual sensor reading; make a first determination that the first deviation exceeds a prespecified threshold; based on the first determination, make a second determination that the first actual sensor reading does not correspond to first related sensors readings; and based on the second determination, make the first virtual sensor reading a first trusted sensor reading for controlling an aspect of a process associated with the process variable.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a process system in accordance with one or more embodiments.

FIG. 2 shows a system for validation of a field sensor in accordance with one or more embodiments.

FIG. 3A shows an example of a physical process model of a temperature sensor in accordance with one or more embodiments.

FIG. 3B shows an example of a physical process model of a pressure sensor in accordance with one or more embodiments.

FIG. 3C shows an example of a physical process model of a flow sensor in accordance with one or more embodiments.

FIG. 3D shows an example of a physical process model of a level sensor in accordance with one or more embodiments.

FIG. 4 shows a flowchart of a method in accordance with one or more embodiments.

FIG. 5 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for process control with process measurements validation capability. Field sensors may be used to perform process measurements, e.g., measurements of a variable of a chemical process. These field sensors may be in the form of physical transmitters for various process variables such as temperature, pressure, flow, etc. In order to detect possible inaccuracies or failures of the field sensors, embodiments of the disclosure provide an alternative control solution based on a virtual sensor that uses computer vision to validate process measurements. Accordingly, embodiments of the disclosure may be beneficial for critical process control that requires high accuracy and data reliability. Embodiments of the disclosure are capable of identifying inconsistencies between an actual sensor reading obtained from a field sensor, and a virtual sensor reading that is separately obtained. Embodiments of the disclosure generate a trusted sensor reading based on the actual sensor reading and the virtual sensor reading. Whether the actual sensor reading or the virtual sensor reading is used as the trusted sensor reading may depend on additionally obtained related sensors readings. The virtual sensor reading may, thus, serve as a backup source or alternative for a sensor reading when an actual sensor reading is not available or inaccurate. A detailed description is subsequently provided with reference to the figures.

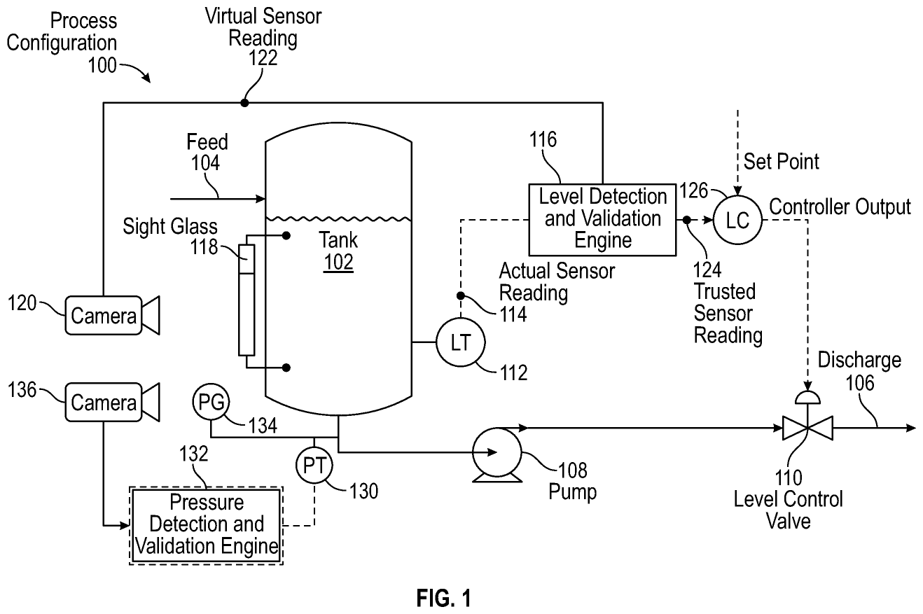

FIG. 1 shows a schematic diagram of a process configuration, in accordance with one or more embodiments. The process configuration (100) may be for any kind of process, such as a petrochemical process. The process configuration (100), in the example, includes a tank (102) that receives fluid (feed (104)) and discharges fluid (discharge (106)). A pump (108) may support the discharge (106), and a level control valve (110) may regulate the discharge (106) to maintain a desired fluid level in the tank (102).

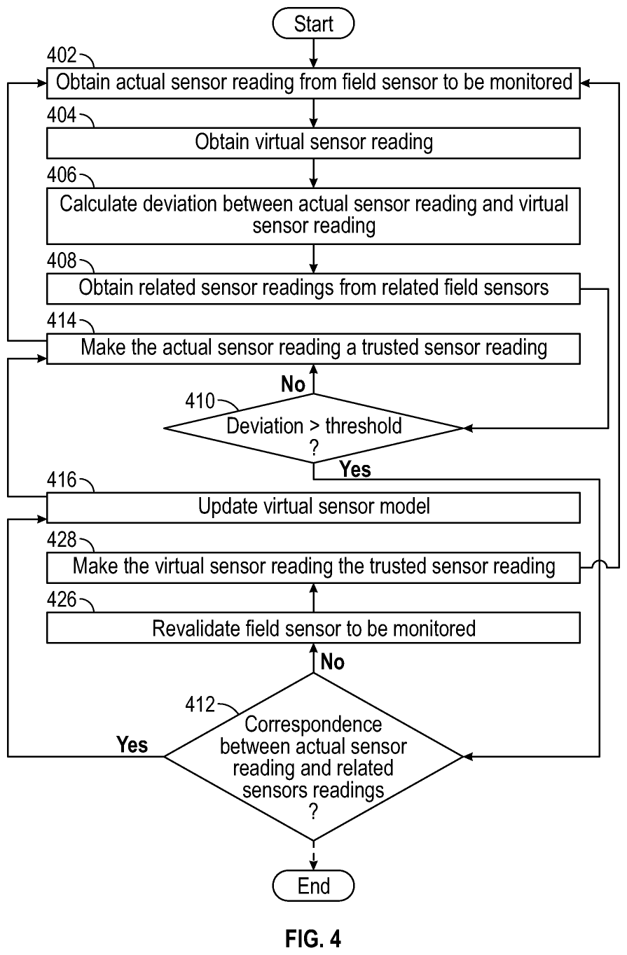

In the example, a level transmitter (112) measures the fluid level in the tank. In other words, the process variable being measures is the fluid level. The level transmitter (112) may be based on any measurement principle, without departing from the disclosure. The level transmitter (112) reports an actual sensor reading (114) to a level detection and validation engine (116). In addition, the level detection and validation engine (116) receives a virtual sensor reading (122) that is visually obtained using methods of image processing from an image of a sight glass (118) in the wall of the tank (102). The image may be captured by a camera (120). In other words, the virtual sensor reading (122) is obtained using a sensing configuration different from the level transmitter (112). The virtual sensor reading, in one embodiment, is obtained from a gauge (in this case a sight glass) originally designed for manual reading by an operator inspecting the gauge. In one or more embodiments, the level detection and validation engine (116) operates on the actual sensor reading (114) and the virtual sensor reading (122) to determine a trusted sensor reading (124) which is provided to a level controller (126). A detailed description of the generation of the trusted sensor reading (124) is provided below in reference to the flowchart of FIG. 4. The level controller (126) may compare the trusted sensor reading (124) to a set point in order to generate a controller output that may be used as a command for controlling an aspect of the process, e.g., by adjusting the level control valve (110).

The process configuration (100) further includes a pressure transmitter (130), a pressure detection and validation engine (132), a pressure gauge (134), and a camera (136) that generate a trusted sensor reading for pressure, as previously described for the level detection.

While FIG. 1 shows a particular configuration of components of a liquid storage system, other configurations may be used without departing from the scope of the disclosure. Additional components, e.g., additional sensors may further be included in the process configuration (100) as further discussed below.

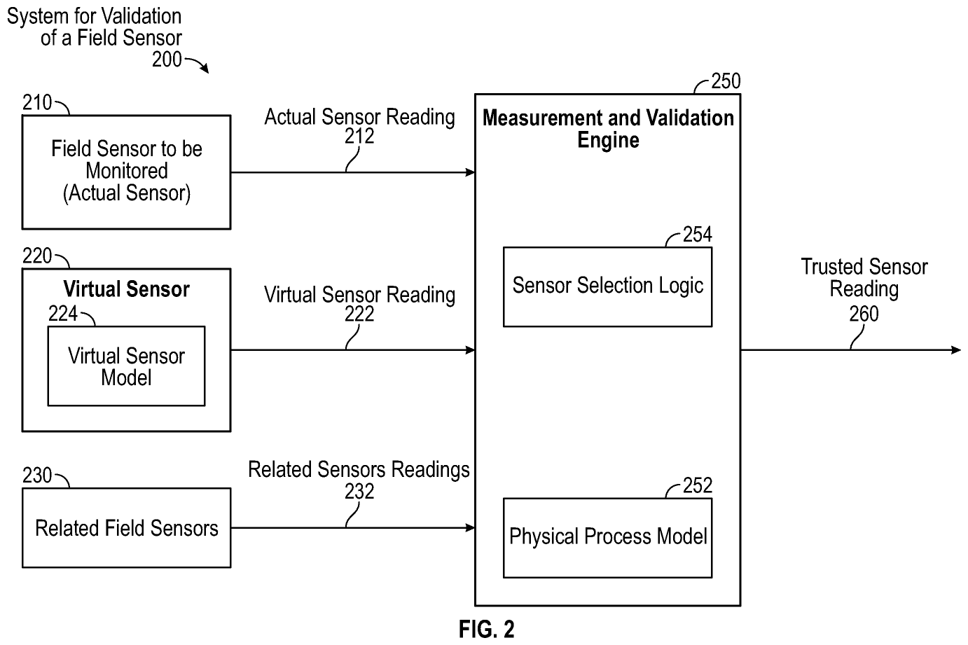

FIG. 2 shows a system for validation of a field sensor in accordance with one or more embodiments. The system (200) includes a field sensor to be monitored (210) that outputs an actual sensor reading (212), a virtual sensor that outputs a virtual sensor reading (222), related field sensors (230) that output related sensors readings (232), and a measurement and validation engine (250) that generates a trusted sensor reading (260). Each of these components is subsequently described.

The field sensor to be monitored (210) may be any type of transmitter, e.g., a level transmitter, a pressure transmitter, a temperature transmitter, etc. The field sensor to be monitored (210) may communicate an actual sensor reading (212) using any type of interface to the measurement and validation engine (250).

The actual sensor reading (212) may be a measurement of an underlying process variable, e.g., a level, pressure, or temperature measurement, etc. The accuracy of the actual sensor reading (212) may be unknown, initially.

The virtual sensor (220) may be a camera-based sensor. A camera-based sensor may be established using a video camera that faces a physical gauge, e.g., a physical radial analog gauge for pressure, temperature, flow, fluid level, etc. The camera may continuously capture the physical radial analogue gauge and feed the image frames into a virtual sensor model (224).

The virtual sensor model (224) may include, for example, an image recognition algorithm to estimate the gauge reading in real-time with its timestamp. In one embodiment, computer vision techniques are used to pre-process the image frames to identify a region of interest (ROI) and to detect the circular dial (in case of a circular gauge), the line indicator (needle), the contour (scale), and the needle angle. The angle is then converted into the virtual sensor reading (222). Gauge reading recognition may also be performed by developing an image regression model based on a convolutional neural network that can associate a video frame (image) with the corresponding process measurement. The image regression model may be trained, for example, in a testing (lab) environment, where there is continuous change in process measurements covering the whole scale in different scenarios. For the training, a camera is installed in front of the analogue gauge to capture the gauge reading visually and a physical sensor is installed on with a transmitter that continuously sends process measurements to a data historian. The training dataset is built using the captured images as inputs (features) and the transmitter measurements as labels.

Other configurations may be used for linear indicators such as sight glasses. Typically, tanks/vessels are equipped with sight glasses on the walls to enable visual monitoring of liquid level inside the tank/vessel. A virtual level sensor may be constructed by installing a video camera that continuously captures the sight glass visuals (scale) and feed the image frames into a level detection algorithm (based on image recognition) to estimate the liquid level value in real-time with its timestamp. One way to implement the level detection algorithm is based on traditional computer vision techniques, where the input image frame is first pre-processed to identify an ROI, and an edge detection algorithm may subsequently be applied to detect a liquid height. Based on a scale, the detected liquid height may be converted to a level value.

Level detection may also be performed by developing an image regression model based on convolutional neural network that can associate a video frame (image) with the corresponding level measurement. The model may be trained, for example, in a testing (lab) environment, where there is continuous change in level measurement covering the whole scale in different scenarios. A camera is installed in front of the sight glass to capture the level visually and a physical level sensor is installed on the tank/vessel with a transmitter that continuously sends level measurements to a data historian. The training dataset is built using the captured images as inputs (features) and the level transmitter measurements as labels.

While only a few examples have been provided, other types of camera-based virtual sensors (220) that provide a virtual sensor reading (222) corresponding to the actual sensor reading (212) may be implemented without departing from the disclosure.

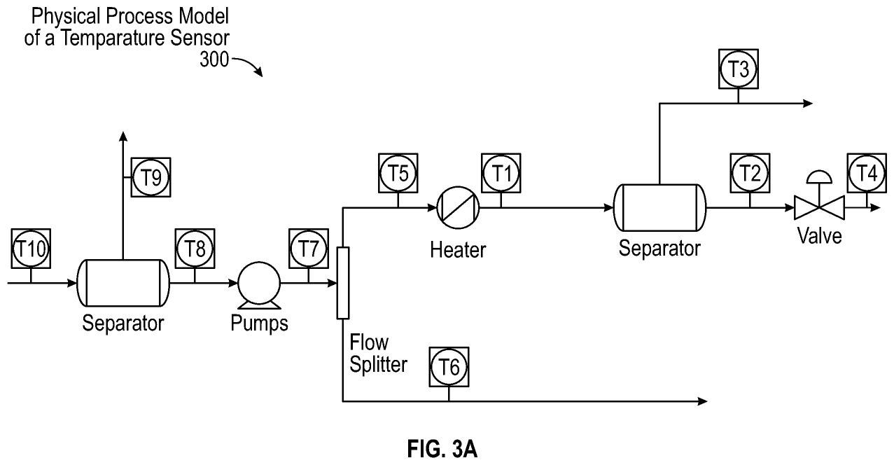

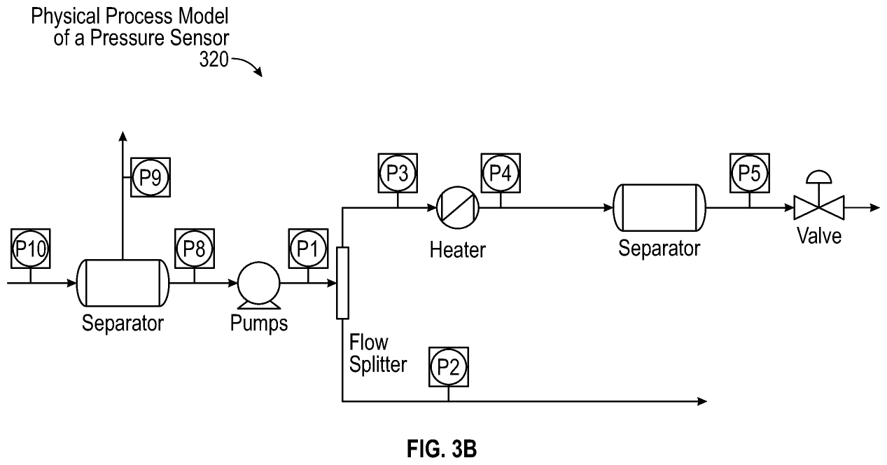

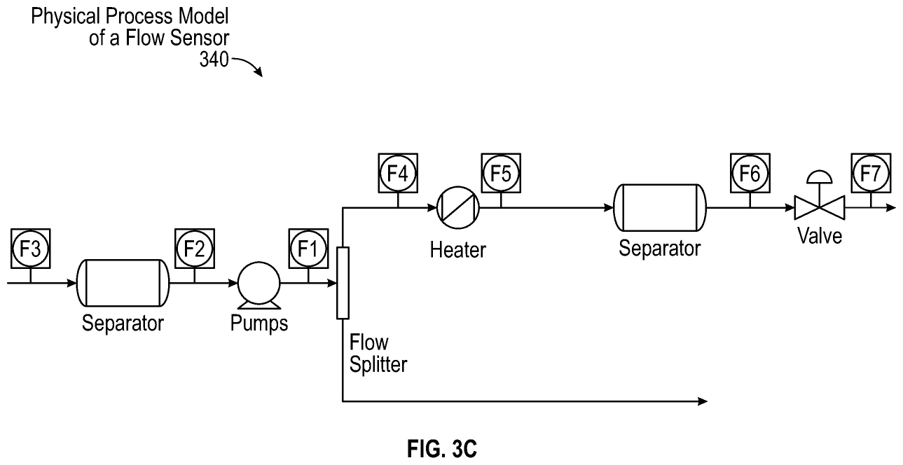

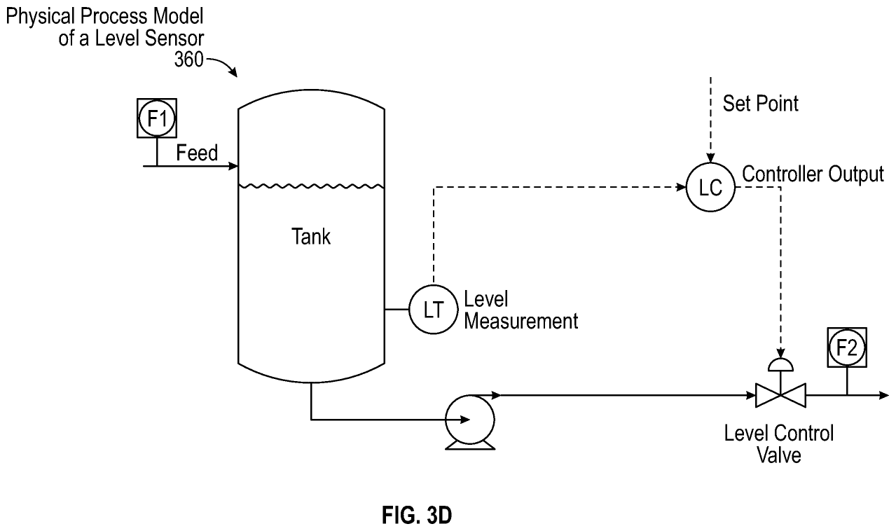

The related field sensors (230) may be sensors that, directly or indirectly, provide at least a certain degree of redundancy with the field sensor to be monitored (210). For example, for a field sensor to be monitored (210) that is a temperature sensor, the related field sensors (230) may also include temperature sensors that may enable cross-validation with the field sensor to be monitored (210). Various examples are provided below in reference to FIGS. 3A, 3B, and 3C. The related field sensors (230) and the field sensor to be monitored (210) may use the same or different measurement principles. The related field sensors (230) output related field sensors readings (232).

The measurement and validation engine (250), in one or more embodiments, operates on the actual sensor reading (212), the virtual sensor reading (222), and the related sensors readings (232) to generate a trusted sensor reading (260). In one embodiment, the trusted sensor reading (260) is selected from the actual sensor reading (212) and the virtual sensor reading (222) based on which one of these two readings is most likely to be more accurate. The selection between the actual sensor reading (212) and the virtual sensor reading (222) is performed under consideration of the related sensors readings (232) and a physical process model (252), discussed below in reference to FIGS. 3A-3D. These operations may be performed by a sensor selection logic (254) which implements the method described below in reference to FIG. 4.

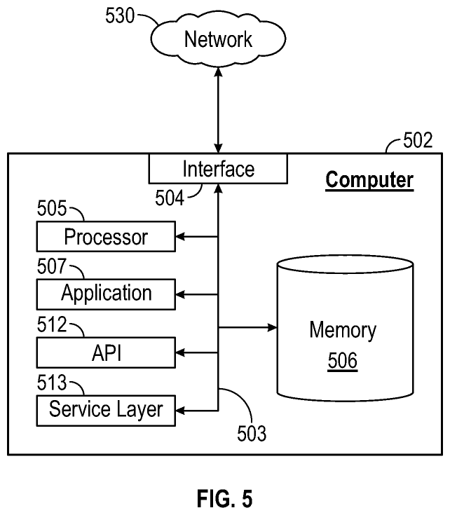

The sensor selection logic (254) may include instructions that may be stored on a non-transitory computer-readable medium and that may be executed on a programmable logic control (PLC) system that can be developed or programmed on a distributed control system (DCS) of the plant. Other computer systems may be used, without departing from the disclosure. An example of a computer system is provided in FIG. 5.

FIGS. 3A-3D show various physical process models in accordance with one or more embodiments, a validation of an actual sensor reading may be performed using the related sensors readings, under consideration of the applicable physical process model. A general assumption may be that, within the process, sensors that are in close proximity to each other are exposed to similar conditions, as discussed in detail below.

FIG. 3A shows an example of a physical process model of a temperature sensor in accordance with one or more embodiments. The example (300) includes various equipment, including a heater. Heating or cooling are assumed to be the only processes that can change the temperature significantly for liquid operations. Accordingly, in the example (300), the temperature sensors T1, T2, T3 and T4 may be validated against each other, while the temperature sensors T5, T6, T7, T8, T9, T10 may be validated against each other. For example, the most basic assumption may be that T1, T2, T3 and T4 indicate approximately the same temperature, whereas a deviation of one of the sensor readings would suggest that the corresponding sensor is malfunctioning. A variation of the sensor readings in the T1-T4 group or the T5-T10 group of no more than a threshold (e.g., 10%) may be deemed acceptable. Now referring back to FIG. 2, and assuming that temperature sensor T1 is the field sensor to be monitored (210), temperature sensors T2-T4 may be used as the related field sensors (230). In this case, the physical process model (252), would suggest the used of temperature sensors T2-T4 to obtain the related sensors readings (232) for further processing by the sensor selection logic (254), as discussed below.

FIG. 3B shows an example of a physical process model of a pressure sensor in accordance with one or more embodiments. The example (320) includes the equipment previously shown in FIG. 3A. The equipment includes a pump. Pumps are assumed to be the only processes that may change the pressure significantly for a liquid operation as shown in the example (320). Accordingly, pressure sensors P1, P2, P3 and P4, and P5 may be validated against each other while pressure sensors P8, P9, and P10 may also be validated against each other. Related sensors readings (232) may thus be obtained for pressure as previously described in reference to FIG. 3A, based on pressure readings obtained from pressure sensors P1-P5, or based on pressure readings obtained from sensors P8-P10 depending on the location of the actual sensor under validation. In the example (320), pressure readings of P1-P7 are assumed to be higher than pressure readings of P8-P10, when the pump is operating. Within a group of pressure sensors, a pressure deviation of no more than a threshold (e.g., 5%) may be considered normal. While not explicitly shown, other sensors may also be used for the validation of a pressure reading. For example, flow sensors may be used to validate pressure, based on the known physics of flow and pressure.

FIG. 3C shows an example of a physical process model of a flow sensor in accordance with one or more embodiments. The example (340) includes the equipment previously shown in FIG. 3A. The equipment includes a flow splitter. Flow splitters are assumed to be the only processes that may change the flow significantly for a liquid operation as shown in the example (320). A flow splitter is a device that may result in a change of the flow significantly for liquid operations as shown in the example (340). Accordingly, flow sensors F1, F2, & F3 may be validated against each other while F4, F5, F6 & F7 may be validated against each other. Related sensors readings (232) may thus be obtained for flow as previously described in reference to FIG. 3A, based on flow readings obtained from flow sensors F1-F3, or based on flow readings obtained from sensors F4-F7 depending on the location of the actual sensor under validation. In the example (340), flow readings of F1-F3 are assumed to be higher than flow readings of F4-F7. Within a group of flow sensors, a flow deviation of no more than a threshold (e.g., 5%) may be considered normal.

FIG. 3D shows an example of a physical process model of a level sensor in accordance with one or more embodiments. The example (360) includes some of the equipment previously shown in FIG. 1, including a tank. A change in the tank's level is a result of flow from and into the tank. Therefore, the level sensor may be validated by using the data from feed and outlet flow meters. Such a validation may be performed using a mass balance equation, which may be conducted over some time period (t):

$$Δ {L}_{b} = \frac{F 1 - F 2}{C} ,$$

where ΔL_{b} is change in level obtained by the balance equation and C is the cross-sectional area of a tank. This equation assumes that the density of the fluid is constant and equal at flow sensors F1, F2, and within the tank. This may be the case in most practical circumstances. The balance equation may be modified to add a density correction in case it is needed. Moreover, a variable cross-sectional C(L) can be used with some modification to the equation. A related sensor reading (232) may thus be obtained for fluid level as previously described in reference to FIG. 3A, based on flow readings obtained from flow sensors F1 and F2. Specifically, an actual ΔL observed over time using an actual sensor reading (212) may be compared to ΔL_{b} obtained from the balance equation. Assuming that there are multiple redundant sensors, the sensor with the largest absolute difference |ΔL_{b}−ΔL| may be assumed to be malfunctioning.

While FIGS. 3A-3D provide various examples, those skilled in the art will recognize that, more generally, a physical process model may be used to identify a correlation between readings of the field sensor to be monitored and related field sensors, thereby enabling a cross-checking. When the reading of the field sensor to be monitored changes along with the readings of the related field sensors according to the physical process model, one may conclude that the reading of the field sensor to be monitored is accurate. When a deviation above a pre-specified threshold is detected, one may question the reliability of the reading of the field sensor to be monitored.

FIG. 4 shows a flowchart in accordance with one or more embodiments. The flowchart of FIG. 4 introduces operations performed to validate a field sensor, in accordance with one or more embodiments. One or more steps in FIG. 4 may be performed by the measurement and validation engine (250). While the various steps in FIG. 4 are presented and described sequentially, one of ordinary skill in the art will appreciate that some or all of the steps may be executed in different orders, may be combined or omitted, and some or all of the steps may be executed in parallel. Furthermore, the steps may be performed actively or passively. The result of the execution of the described method may be a trusted sensor reading, which may be used to control an aspect of the underlying process. For example, based on the trusted sensor reading, a control valve, set point, etc.may be adjusted.

Turning to the flowchart, in Step 402, an actual sensor reading of a process variable is obtained from the field sensor to be monitored. A single actual sensor reading may be obtained, or a series of actual sensor readings may be obtained, e.g., at set time intervals.

In Step 404, a virtual sensor reading of the process variable is obtained. The obtaining of the virtual sensor reading may be camera-based and may involve methods of image processing, as previously described. The virtual sensor reading may be obtained simultaneously or approximately simultaneously with the actual sensor reading.

In Step 406, a deviation between the actual and virtual sensor readings is calculated. The deviation may be calculated using the formula

$$D = \frac{\vert VSR - ASR \vert}{VSR} * 100 ,$$

where VSR represents the virtual sensor reading and ASR represents the actual sensor reading. The deviation may be calculated based on instantaneous readings or taking historical readings from the sensors over the last (T) minutes/days to obtain an average deviation or a correlation coefficient over time.

In Step 408, one or more related sensor readings are obtained from one or more related field sensors. Many additional sensors may exist for a process configuration, and a physical process model may be used to select a subset of related sensors and/or to perform operations to generate a related sensor reading, e.g., as described based on the examples shown in FIGS. 3A-3D. The related one or more sensor readings may be obtained simultaneously or approximately simultaneously with the actual sensor reading.

In Step 410, a test is performed to determine whether the deviation between the actual sensor reading and the virtual sensor reading exceeds a pre-specified threshold. An absolute number or a percentage threshold may be used. If the deviation exceeds the threshold, the method may proceed with the execution of Step 412. If the deviation does not exceed the threshold, the method may proceed with the execution of Step 414, where the actual sensor reading is determined to be correct and may be used for subsequent operations, such as for making adjustments to the execution of the process (e.g., opening or closing a valve, adjusting a heater, etc.).

In Step 412, a test is performed to determine whether a correspondence between the actual sensor reading and the related sensors readings exists. Such a correspondence may be found, for example, when a change in the actual sensor reading is accompanied by a corresponding change of the related sensors readings.

The correspondence between related sensors readings may be identified in different ways. One way is to construct a set of validation rules (mathematical inequalities between the sensors) based on the physical model of the process (as discussed in reference to FIGS. 3A-3D). Alternatively, a simulation model of the underlying process (e.g., a digital twin) may be constructed, and simulated sensor values may be obtained from the simulation model as it is driven by real process data. In one or more embodiments, a machine learning model may be used to correlate the actual sensor reading with the related sensors readings. For example, the user may designate a certain period of time to collect training data from multiple related sensors, ensuring that the collected data is clean and correct (without sensor malfunctioning). The collected data may be utilized to train a machine learning model to predict the reading of one sensor (the actual sensor under validation) based on the readings of the other sensors (related sensors). Correspondence exists if the model predicted value matches the actual sensor reading within a certain accuracy.

If there is a corresponding change in the related sensors readings, it may be concluded that the virtual senor reading, produced by the virtual sensor model is inaccurate. It may further be assumed that the actual sensor reading is accurate. In this case, the execution of the method may proceed with Step 416.

In Step 416, the virtual sensor model is updated, based on the conclusion that the virtual sensor model is invalid and requires troubleshooting. The troubleshooting may involve any kind of re-training of the virtual sensor model (e.g., adapting to new environmental conditions) that is expected to improve the performance of the virtual sensor model. It may also involve fixing the image capturing device or adjusting the environmental conditions that affect the quality of the captured images (lighting, shadow, contrast, etc.). The execution of the method may then proceed with previously described Step 414.

If there is no corresponding change in the related sensors readings, it may be concluded that the actual sensor reading, obtained from the field sensor to be monitored, is inaccurate. In this case, the execution of the method may proceed with Step 426.

In Step 426, the field sensor to be monitored is revalidated. The revalidation may involve inspecting the sensor for accuracy, potentially recalibrating, repairing, or replacing the sensor, etc.

In Step 428, the virtual sensor reading is determined to be correct and may be used for subsequent operations, such as for adjusting the execution of the process.

The trusted sensor reading may then be used for controlling an aspect of the process associated with the process variable. The operations described in reference to FIG. 4 may be repeatedly executed, for example, in a loop, thereby enabling a continuous sensing. Further, while FIG. 4 shows steps for a single field sensor to be monitored, the method may be executed for any number of field sensors.

Embodiments may be implemented on a computer system. FIG. 5 is a block diagram of a computer system (502) used to provide computational functionalities associated with described algorithms, methods, functions, processes, flows, and procedures as described in the instant disclosure, according to an implementation. The illustrated computer (502) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (502) may include a computer that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other component (or a combination of roles) of a computer system for performing the subject matter described in the instant disclosure. The illustrated computer (502) is communicably coupled with a network (530). In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (530) from a client application (for example, executing on another computer (502)) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (503). In some implementations, any or all of the components of the computer (502), both hardware or software (or a combination of hardware and software), may interface with each other or the interface (504) (or a combination of both) over the system bus (503) using an application programming interface (API) (512) or a service layer (513) (or a combination of the API (512) and service layer (513). The API (512) may include specifications for routines, data structures, and object classes. The API (512) may be either computer-language independent or dependent and refer to a complete interface, a single function, or even a set of APIs. The service layer (513) provides software services to the computer (502) or other components (whether or not illustrated) that are communicably coupled to the computer (502). The functionality of the computer (502) may be accessible for all service consumers using this service layer. Software services, such as those provided by the service layer (513), provide reusable, defined business functionalities through a defined interface. For example, the interface may be software written in JAVA, C++, or other suitable language providing data in extensible markup language (XML) format or other suitable format. While illustrated as an integrated component of the computer (502), alternative implementations may illustrate the API (512) or the service layer (513) as stand-alone components in relation to other components of the computer (502) or other components (whether or not illustrated) that are communicably coupled to the computer (502). Moreover, any or all parts of the API (512) or the service layer (513) may be implemented as child or sub-modules of another software module, enterprise application, or hardware module without departing from the scope of this disclosure.

The computer (502) includes an interface (504). Although illustrated as a single interface (504) in FIG. 5, two or more interfaces (504) may be used according to particular needs, desires, or particular implementations of the computer (502). The interface (504) is used by the computer (502) for communicating with other systems in a distributed environment that are connected to the network (530). Generally, the interface (504 includes logic encoded in software or hardware (or a combination of software and hardware) and operable to communicate with the network (530). More specifically, the interface (504) may include software supporting one or more communication protocols associated with communications such that the network (530) or interface's hardware is operable to communicate physical signals within and outside of the illustrated computer (502).

The computer (502) includes at least one computer processor (505). Although illustrated as a single computer processor (505) in FIG. 5, two or more processors may be used according to particular needs, desires, or particular implementations of the computer (502). Generally, the computer processor (505) executes instructions and manipulates data to perform the operations of the computer (502) and any algorithms, methods, functions, processes, flows, and procedures as described in the instant disclosure.

The computer (502) also includes a memory (506) that holds data for the computer (502) or other components (or a combination of both) that can be connected to the network (530). For example, memory (506) can be a database storing data consistent with this disclosure. Although illustrated as a single memory (506) in FIG. 5, two or more memories may be used according to particular needs, desires, or particular implementations of the computer (502) and the described functionality. While memory (506) is illustrated as an integral component of the computer (502), in alternative implementations, memory (506) can be external to the computer (502).

The application (507) is an algorithmic software engine providing functionality according to particular needs, desires, or particular implementations of the computer (502), particularly with respect to functionality described in this disclosure. For example, application (507) can serve as one or more components, modules, applications, etc. Further, although illustrated as a single application (507), the application (507) may be implemented as multiple applications (507) on the computer (502). In addition, although illustrated as integral to the computer (502), in alternative implementations, the application (507) can be external to the computer (502).

There may be any number of computers (502) associated with, or external to, a computer system containing computer (502), each computer (502) communicating over network (530). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

In some embodiments, the computer (502) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for process control with process measurements validation capability, the method comprising:
obtaining a first actual sensor reading of a process variable from a field sensor to be monitored;
obtaining a first virtual sensor reading of the process variable from a virtual sensor, wherein the virtual sensor is camera-based;
calculating a first deviation between the first actual sensor reading and the first virtual sensor reading;
making a first determination that the first deviation exceeds a prespecified threshold;
based on the first determination, making a second determination that the first actual sensor reading does not correspond to first related sensors readings; and
based on the second determination, making the first virtual sensor reading a first trusted sensor reading for controlling an aspect of a process associated with the process variable.

2. The method of claim 1, further comprising:
based on the second determination, revalidating the field sensor to be monitored.

3. The method of claim 1, further comprising:
obtaining a second actual sensor reading;
obtaining a second virtual sensor reading;
calculating a second deviation between the second actual sensor reading and the second virtual sensor reading;
making a third determination that the second deviation exceeds the prespecified threshold;
based on the third determination, making a fourth determination that the second actual sensor reading does correspond to second related sensors readings; and
based on the fourth determination, making the second actual sensor reading a second trusted sensor reading.

4. The method of claim 3, further comprising:
based on the fourth determination, updating a virtual sensor model.

5. The method of claim 1, further comprising:
obtaining a second actual sensor reading;
obtaining a second virtual sensor reading;
calculating a second deviation between the second actual sensor reading and the second virtual sensor reading;
making a third determination that the second deviation does not exceeds the prespecified threshold; and
based on the third determination, making the second actual sensor reading a second trusted sensor reading.

6. The method of claim 1, wherein the process variable is one selected from a group consisting of a temperature, a pressure, a flow, and a level.

7. The method of claim 1, wherein obtaining the first virtual sensor reading comprises:
capturing an image of a physical gauge; and
processing the image to obtain the virtual sensor reading.

8. The method of claim 1, wherein the first related sensors readings are obtained using related field sensors, different from the field sensor to be monitored, and where the related field sensors are selected based on at least one selected from a group consisting of a physical process model of the process and a machine learning model.

9. The method of claim 8, wherein the physical model or the machine learning model is used to identify a correlation between readings of the related field sensors and the field sensor to be monitored.

10. A system for process control with process measurements validation capability, the system comprising:
a field sensor to be monitored, configured to obtain a first actual sensor reading of a process variable;
a virtual sensor comprising a camera, the virtual sensor configured to obtain a first virtual sensor reading of the variable;
related field sensors, configured to obtain first related sensors readings; and
a measurement and validation engine configured to:
calculate a first deviation between the first actual sensor reading and the first virtual sensor reading,
make a first determination that the first deviation exceeds a prespecified threshold,
based on the first determination, make a second determination that the first actual sensor reading does not correspond to the first related sensors readings, and
based on the second determination, making the first virtual sensor reading a first trusted sensor reading for controlling an aspect of a process associated with the process variable.

11. The system of claim 10, wherein the measurement and validation engine is further configured to:
based on the second determination, revalidate the field sensor to be monitored.

12. The system of claim 10, wherein the measurement and validation engine is further configured to:
obtain a second actual sensor reading,
obtain a second virtual sensor reading,
calculate a second deviation between the second actual sensor reading and the second virtual sensor reading,
make a third determination that the second deviation exceeds the prespecified threshold,
based on the third determination, make a fourth determination that the second actual sensor reading does correspond to second related sensors readings, and
based on the fourth determination, make the second actual sensor reading a second trusted sensor reading.

13. The system of claim 12, wherein the measurement and validation engine is further configured to:
based on the fourth determination, update a virtual sensor model.

14. The system of claim 10, wherein the measurement and validation engine is further configured to:
obtain a second actual sensor reading,
obtain a second virtual sensor reading,
calculate a second deviation between the second actual sensor reading and the second virtual sensor reading,
make a third determination that the second deviation does not exceeds the prespecified threshold, and
based on the third determination, make the second actual sensor reading a second trusted sensor reading.

15. The system of claim 10, wherein the process variable is one selected from a group consisting of a temperature, a pressure, a flow, and a level.

16. The system of claim 10, wherein obtaining the first virtual sensor reading comprises:
capturing an image of a physical gauge, and
processing the image to obtain the virtual sensor reading.

17. The system of claim 1, wherein the first related sensors readings are obtained using related field sensors, different from the field sensor to be monitored, and where the related field sensors are selected based on at least one selected from a group consisting of a physical process model of the process and a machine learning model.

18. The system of claim 17, wherein the physical model or the machine learning model is used to identify a correlation between readings of the related field sensors and the field sensor to be monitored.

19. A non-transitory machine-readable medium comprising a plurality of machine-readable instructions executed by one or more processors of a measurement and validation engine, the plurality of machine-readable instructions causing the one or more processors to perform operations comprising:
obtaining a first actual sensor reading of a process variable from a field sensor to be monitored;
obtaining a first virtual sensor reading of the process variable from a virtual sensor, wherein the virtual sensor is camera-based;
calculating a first deviation between the first actual sensor reading and the first virtual sensor reading;
making a first determination that the first deviation exceeds a prespecified threshold;
based on the first determination, making a second determination that the first actual sensor reading does not correspond to first related sensors readings; and
based on the second determination, making the first virtual sensor reading a first trusted sensor reading for controlling an aspect of a process associated with the process variable.

20. The non-transitory machine-readable medium of claim 19, wherein the operations further comprise:
obtaining a second actual sensor reading;
obtaining a second virtual sensor reading;
calculating a second deviation between the second actual sensor reading and the second virtual sensor reading;
making a third determination that the second deviation exceeds the prespecified threshold;
based on the third determination, making a fourth determination that the second actual sensor reading does correspond to second related sensors readings; and
based on the fourth determination, making the second actual sensor reading a second trusted sensor reading.
